(19) United States
(12) Patent Application Publication
(10) Pub. No.: US 2026/0020135 A1
(43) Pub. Date: Jan. 15, 2026

(54) EFFICIENT COMPACT ELECTRON LINACS

(71) Applicant: Muons, Inc., Batavia, IL (US)

(72) Inventors: Milorad Popovic, Warrenville, IL (US); Rolland Paul Johnson, Newport News, VA (US)

(21) Appl. No.: 19/270,170

(22) Filed: Jul. 15, 2025

Related U.S. Application Data
(60) Provisional application No. 63/671,444, filed on Jul. 15, 2024.

(51) Int. Cl. H05H 9/00; H05H 7/02; H05H 7/20

(52) U.S. Cl. CPC H05H 9/00; H05H 7/02; H05H 7/20; H05H 2007/025; H05H 2007/027

(57) ABSTRACT

A system for producing a high-speed beam of electrons can include a racetrack microtron (RTM) powered by a magnetron. The RTM can include a linear accelerator (linac) integrated with a racetrack-shaped beam path to accelerate a beam of electrons using continuous wave (CW) radio-frequency (RF) electromagnetic energy provided by the magnetron.

### CLAIM OF PRIORITY

The present application claims the benefit of priority under 35 U.S.C. § 119(e) of U.S. Provisional Patent Application No. 63/671,444, entitled “EFFICIENT COMPACT ELECTRON LINAC”, filed on Jul. 15, 2024, which is herein incorporated by reference in its entirety.

### TECHNICAL FIELD

This document relates generally to electron accelerators and more particularly, but not by way of limitation, to a compact efficient continuous wave electron accelerator.

### BACKGROUND

Electron accelerators have been used in various industrial applications (e.g., polymer modification, food preservation, and water treatment) and medical applications (e.g., sterilization and radiotherapy). The electron linear accelerator (linac) is a proven tool in many different applications. Therefore, there is a growing demand for advanced electron acceleration technology that can provide a linac system with improved efficiency, reliability, and mobility.

### SUMMARY

A system for producing a high-speed beam of electrons can include a racetrack microtron (RTM) powered by a magnetron. The RTM can include a linear accelerator (linac) integrated with a racetrack-shaped beam path to accelerate a beam of electrons using continuous wave (CW) radio-frequency (RF) electromagnetic energy provided by the magnetron.

An example of a system for producing a high-speed beam of electrons is provided. The system can include an RTM and a magnetron. The RTM can be configured to receive a beam of electrons and to accelerate the received beam of electrons using CW RF electromagnetic energy. The RTM can includes a linac integrated with a racetrack-shaped beam path including two semicircular sections connected between two straight sections. The magnetron can be coupled to the RTM and configured to provide the RTM with the CW RF electromagnetic energy. The linac and the beam path can be configured for low gradient acceleration of the beam of electrons that requires a peak RF power available from the magnetron.

An example of a method for producing a high-speed beam of electrons is also provided. The method can include accelerating a beam of electrons using an RTM powered by CW RF electromagnetic energy. The RTM can include a linac integrated with a racetrack-shaped beam path including two semicircular sections connected between two straight sections. The method can further include providing the RTM with the CW RF electromagnetic energy produced by a magnetron. The linac and the beam path can be configured for low gradient acceleration of the beam of electrons that requires a peak RF power available from the magnetron.

This Summary is an overview of some of the teachings of the present application and not intended to be an exclusive or exhaustive treatment of the present subject matter. Further details about the present subject matter are found in the detailed description and appended claims. Other aspects of the disclosure will be apparent to persons skilled in the art upon reading and understanding the following detailed description and viewing the drawings that form a part thereof, each of which are not to be taken in a limiting sense. The scope of the present disclosure is defined by the appended claims and their legal equivalents.

### BRIEF DESCRIPTION OF THE DRAWINGS

The drawings illustrate generally, by way of example, various embodiments discussed in the present document. The drawings are for illustrative purposes only and may not be to scale.

FIG. 1 is a block diagram illustrating an embodiment of a system for producing a high-speed beam of electrons.

FIG. 2 is a block diagram illustrating another embodiment of a system for producing a high-speed beam of electrons.

FIG. 3 illustrates an embodiment of a system as an example of portions of the system of FIG. 2.

FIG. 4 is a flow chart illustrating an embodiment of a method for producing a high-speed beam of electrons.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized, and that structural, logical and electrical changes may be made without departing from the spirit and scope of the present invention. References to “an”, “one”, or “various” embodiments in this disclosure are not necessarily to the same embodiment, and such references contemplate more than one embodiment. The following detailed description provides examples, and the scope of the present invention is defined by the appended claims and their legal equivalents.

This document discusses, among other things, a compact efficient continuous wave (CW) electron accelerator system that can meet the increasing demand for advanced electron acceleration technology. The system can integrate gridded electron gun to improve electron capture efficiency and magnetron technology for radio-frequency (RF) power to ensure efficiency and mobility. The system's modularity and flexibility cater to diverse applications, including Cobalt-60 (⁶⁰Co) replacement, isotope production, medical sterilization, food and water processing. Key features such as magnetron RF source and permanent magnets reduce costs and enhance portability. The system can employ a 1,497 MHz magnetron developed by Muons, Inc. (Batavia, Illinois, U.S.A.) for compactness and efficiency. Such a magnetron is discussed, for example, in M. Popovic et al., “Development and Testing of High Power CW 1497 MHz magnetron”, Proceedings of the 13th Int. Particle Acc. Conf (IPAC2022), Bangkok, Thailand (June 2022), 1351-1353, which is herein incorporated by reference in its entirety. The accelerator design can utilize a single linear accelerator (linac) and racetrack configuration, ensuring gradual acceleration while minimizing footprint. The system can further integrate Niobium-tin (Nb₃Sn)-based superconducting cavities for higher beam energies and scalability. In various embodiments, a compact electron linac system according to the present subject matter can offer a cost-effective and versatile solution that is poised to revolutionize electron beam applications across industries.

Using magnetron technology as the CW RF power source, the present system can be characterized by compactness, efficiency, and robustness, setting new benchmarks in the realm of electron acceleration. Designed as a turnkey solution, the present system can offer plug-and-play functionality, enabling seamless integration into diverse operational environments. Additionally, the present system can have a mobility that ensures versatility, allowing for deployment in various settings ranging from research facilities to industrial applications.

The present subject matter encapsulates the concept of an efficient, compact, and contemporary electron linac. The foundational components are designed with modularity in mind, facilitating easy replacement with even more efficient alternatives anticipated to emerge in the near future. By employing a magnetron as the RF power source, significant reductions in power requirements, size, cost, and operational efficiency are achieved, ultimately enhancing affordability and accessibility. The consequential reduction in size enables the entire installation to be condensed onto a medium-sized truck, optimizing space utilization without compromising functionality. Moreover, the diminished power consumption resulting from the utilization of magnetrons and permanent magnets renders the unit mobile, unlocking a myriad of potential applications across diverse operational landscapes.

There is an increasing global demand for affordable, efficient, and compact/mobile electron beam solutions across various sectors, including, for example: (a) replacement of Cobalt-60 sources: the need to replace Cobalt-60 radiation sources with safer and more efficient alternatives; (b) isotope production and medical accelerator treatment: accelerators utilized in isotope production and medical treatments, necessitating reliable and cost-effective solutions; (c) medical sterilization via electron beams: utilizing electron beams for medical sterilization purposes, ensuring safety and efficacy in healthcare settings; (d) electron beams for food processing: employing electron beams for food processing applications, enhancing food safety and preservation; and (e) electron beam for water processing: utilizing electron beams for water treatment and purification, addressing water quality concerns. The present subject matter can meet this demand by providing an electron linac characterized by its modularity and flexibility, enabling us to cater to all these applications while ensuring affordability and efficiency.

Examples of features of the present system include:
(1) Utilization of magnetron as RF source: This choice significantly reduces equipment costs. For instance, a CW magnetron-based RF system costs $75,000 for 75 kW at 915 MHz, whereas a similar system based on a solid-state amplifier (1.5 GHz) would cost $90,000 for only 7 kW of RF power. Furthermore, compared to a klystron-based system, which costs approximately $100,000 for 14 kW power, the magnetron-based solution offers a more cost-effective option with higher efficiency.
(2) Integration of permanent magnets: Incorporating permanent magnets for beam recirculation, confinement and steering reduces overall system weight and power consumption, enhancing efficiency and portability.
(3) Folding and recirculating beam with racetrack configuration: These design features minimize the footprint of the system, enabling compactness. Additionally, they allow for a reduction in the number of RF cavities, thereby decreasing RF power loss and investment costs.
(4) Reduction in size: The compact design facilitates the placement of all components on a medium-sized track, optimizing space utilization and enhancing mobility.
(5) Reduced power consumption: Lower power consumption enables the use of small-sized alternator-based power generators, enhancing the mobility of the unit and expanding its operational versatility.
   In various embodiments, using modular and flexible approach, coupled with the utilization of cost-effective technologies such as magnetrons and permanent magnets, the present subject matter provides an electron beam solution as a highly viable and efficient option for addressing a wide range of global needs across various industries.

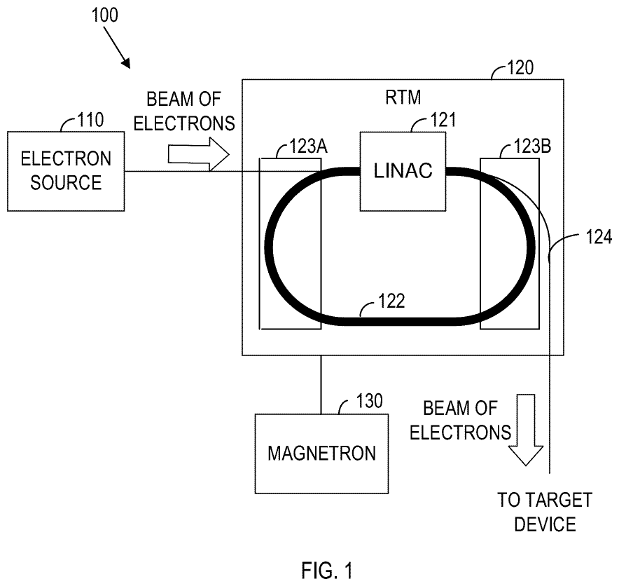

FIG. 1 is a block diagram illustrating an embodiment of a system 100 for producing a high-speed beam of electrons. System 100 can include an electron source 110, a racetrack microtron (RTM) 120, and a magnetron 130.

Electron source 110 can produce a beam of electrons. In one embodiment, electron source 110 includes a gridded electron gun.

RTM 120 can receive the beam of electrons from electron source 110 and accelerate the received beam of electrons using CW RF electromagnetic energy. RTM 120 can be powered by a magnetron providing the CW RF electromagnetic energy. As illustrated in FIG. 1, RTM 120 includes a linac 121 and a racetrack-shaped beam path 122. Linac 121 and beam path 122 can be configured for low gradient acceleration of the beam of electrons that requires a peak RF power available from a single magnetron. Beam path 122 has a racetrack shape including two semicircular sections connected between two straight sections. Linac 121 is integrated into beam path 122 and positioned a straight section of the two straight sections. Linac 121 can receive the beam of electrons and accelerate the received beam of electrons along a straight portion of beam path 122. Linac 121 can include one or more superconducting cavities. In one embodiment, the one or more superconducting cavities are each a niobium-tin (Nb₃Sn)-based superconducting cavity. RTM 120 includes magnets 123A-B each positioned at one of the semicircular sections of beam path 122 to bend the beam of electrons for 180 degrees for recirculation in beam path 122 (i.e., returning the beam of electrons to linac 121) for repeatedly boosting energy of the electrons using linac 121. In one embodiment, magnets 123A-B are permanent magnets. An extraction channel 124 is coupled to beam path 122 to output the high-speed beam of electrons from beam path 122. Extraction channel 124 can guide the output beam of electrons from RTM 120 to a target device that receives the beam of electrons.

In various embodiments, the target device can use the beam of electrons for isotope production, medical treatment, medical sterilization, food processing for enhancing food safety and preservation, water treatment and purification, or another application that uses a beam of electrons. The racetrack configuration of beam path 122 allows the possibility to quickly change the output energy of the extracted beam of electrons. In various embodiments, the energy of the output beam of electrons can be adjusted according to the need of the target device. In one embodiment, electromagnets (e.g., Vernier electromagnets) in addition to the permanent magnets are used to make the orbit of the beam of electrons through extraction channel 124 correspond to a different number of passes through linac 121. In another embodiment, the beam of electrons is extracted from different orbits in the straight section between magnets 123A-B using a fast electrostatic kicker and septum magnet (e.g. Lambertson septum magnet).

Magnetron 130 can generate the CW RF electromagnetic energy and power RTM 120 using the generated energy. An example of magnetron 130 is the 1,497 MHz magnetron developed by Muons, Inc. In one embodiment, magnetron 130 represents a single magnetron. In other embodiments, magnetron 130 represents multiple magnetrons to provide additional power.

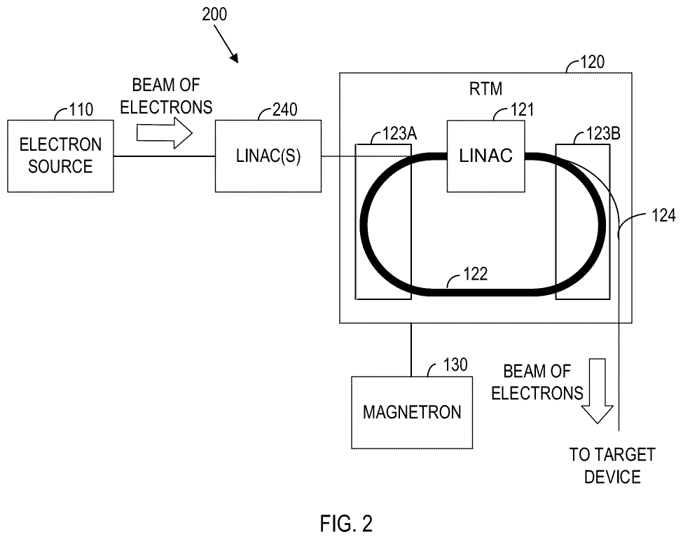

In one embodiment, as illustrated in FIG. 1, RTM 120 is coupled to electron source 110 directly to receive the beam of electrons from electron source 110 directly. In other embodiments, as illustrated in FIG. 2, one or more additional linacs are coupled between electron source 110 and RTM 120 to pre-accelerate the beam of electrons received by RTM 120. FIG. 2 is a block diagram illustrating an embodiment of a system 200 for producing a high-speed beam of electrons. System 200 can include one or more linacs 240 in addition to the components of system 100 (i.e., electron source 110, RTM 120, and magnetron 130). Linac(s) 240 is coupled between electron source 110 and RTM 120 to pre-accelerate the beam of electrons received by RTM 120. For example, linac(s) 240 and RTM 120 can work together to accelerate the beam of electrons to a velocity that asymptotically approaches the velocity of light. In various embodiments, linac(s) 240 can include a single linac or multiple linacs connected in series.

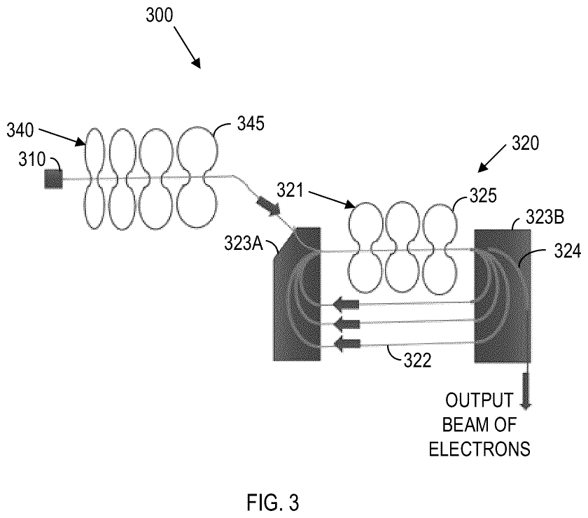

FIG. 3 illustrates an embodiment of a system 300 showing an example of portions of system 200. In the illustrated embodiment, system 300 is a linac racetrack system. In various embodiments, system 300 can generate electron beams up to 1.5 MeV with multi-kilowatt power output. Unlike other electron accelerators, an initial low-energy series of 1,497 MHz RF cavities can be matched to the velocity of the electrons to adiabatically accelerate the beam of electrons to the velocity of light. This approach, often used for more massive particles like protons or ions, reduces beam losses in the first and recirculating stages. Reduced losses mean higher efficiency and less beam induced heating that affects component lifetimes and in the case of upgrading to superconducting cavities, increases the possibility to operate with a cryocooler instead of liquid helium.

In the illustrated embodiment, system 300 includes an electron source 310, a linac 340, and a RTM 320 and is powered by a magnetron such as magnetron 130 (not shown in FIG. 3). Electron source 310 is an example of electronic source 110 and can be a gridded electron gun. Linac 340 is an example of linac 240 and can receive the beam of electrons from electron source 310 and accelerate the received beam of electrons. Linac 340 includes multiple superconducting cavities, such as niobium-tin (Nb₃Sn)-based superconducting cavities. In a specific 1,497 MHz example, linac 340 has 9 cavities having different lengths and gaps and hence different values of beta (β), a gradient (Eₒ) of about 1 MV/m, a length of about 180 cm, a power dissipation of about 6 kW, and an energy of the output beam of electrons of about 530 keV. In the specific 1,497 MHz example, linac 340 is designed to pre-accelerate the beam of electrons such that the electrons travel at a velocity asymptotically approaching the velocity of light.

RTM 320 is an example of RTM 120 and includes linac 321 and a racetrack-shaped beam path 322 to receive the beam of electrons from 340 linac and accelerate the received beam of electrons. Linac 321 is an example of linac 121. Beam path 322 is an example of beam path 122. Magnets 323A-B are an example of magnets 123A-B and can each be a permanent magnet. An extraction channel 324 is an example of extraction channel 124 and can output the high-speed beam of electrons from beam path 322. Linac 321 includes multiple superconducting cavities, such as niobium-tin (Nb₃Sn)-based superconducting cavities. In the specific 1,497 MHz example, RTM 320 including linac 321 and beam path 322 has 3 identical cavities having identical values of beta (β) (e.g., β=1), a gradient (Eₒ) of about 1 MV/m, a magnetic field of about 100 Gauss, a radius of each semicircular section of about 60 cm, a length of the straight section of about 100 cm, a power dissipation of about 2 kW, and an energy of the output beam of electrons about 1.5 MeV. In the specific 1,497 MHz example, RTM 320 receives the pre-accelerated beam of electrons traveling at the velocity approaching the velocity of light from linac 340 and continues to asymptotically approach the velocity of light.

The 1497 MHz RF frequency as an example of operating frequency for system 300 is chosen based on several factors including, for example:
(A) Availability of CW 20 kW magnetron at this frequency: The availability of magnetrons capable of generating CW RF power at 20 kW output at 1,497 MHz ensures reliable and cost-effective operation of our system. This availability facilitates seamless integration of the RF power source into our accelerator design, minimizing equipment costs and streamlining production processes.
(B) Availability of superconducting cavities at this frequency: Additionally, the existence of superconducting cavities operable at the 1,497 MHz frequency provides further support for our frequency selection. Superconducting cavities offer enhanced efficiency and performance compared to traditional RF cavity designs, enabling higher beam energies and improved beam quality. Leveraging these cavities at our chosen frequency enhances the overall effectiveness and capabilities of our electron accelerator system.
(c) Acceptable size of RF components for compactness and mobility: The 1,497 MHz frequency aligns with the desired compactness and mobility goals of our system. RF components designed to operate at this frequency can be engineered to meet stringent size and weight requirements, facilitating the development of a compact and portable accelerator solution. This ensures that our system can be easily housed on a medium-sized track while maintaining optimal performance and efficiency.

To achieve compactness and efficiency, the present system can employ a single linac configuration and racetrack for electron beam acceleration. This configuration allows for the gradual acceleration of the beam to the desired energy level while minimizing the footprint of the accelerator system.

When contemplate the future trajectory of electron beam technology, it becomes evident that the demand for higher beam energy and power will continue to escalate. The present system, although versatile and adaptable, sets the stage for potential advancements that can further enhance its capabilities.

One avenue of development lies in the exploration of Nb₃Sn-based superconducting cavities. These cavities, coupled with cryocooler technology, hold promise for achieving higher beam energies while maintaining efficiency and reliability. By closely monitoring advancements in this field, these cutting-edge components can be integrated into the present system, thereby unlocking greater performance and versatility.

Additionally, utilization of magnetron technology as the RF power source offers scalability and flexibility. As the need for increased beam power arises, the present system can seamlessly accommodate the integration of additional magnetrons, leveraging phase-locking techniques to synchronize their operation. This scalability ensures that the present system remains adaptable to evolving requirements, safeguarding its relevance and longevity in the ever-changing landscape of electron beam applications.

The compact efficient CW electron accelerator according to the present subject matter represents a significant advancement in electron beam technology, offering a cost-effective, efficient, and versatile solution to address a myriad of industrial and medical applications. The present system can not only meets current demands but also lay groundwork for future enhancements.

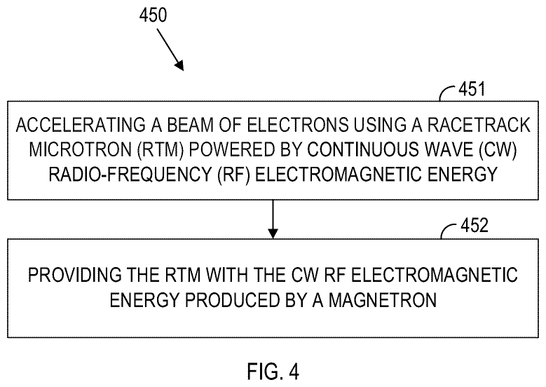

FIG. 4 is a flow chart illustrating an embodiment of a method 450 for producing a high-speed beam of electrons. In various embodiments, method 450 can be performed using system 100, 200, or 300.

At 451, a beam of electrons is accelerated using an RTM powered by CW RF electromagnetic energy. The RTM includes a linac integrated with a racetrack-shaped beam path. The beam path includes two semicircular sections connected between two straight sections. The beam of electrons can be produced using an electron source, such as a gridded electron gun, and injected into the RTM. The beam of electrons can be bent in the beam path using permanent magnets each positioned at the semicircular sections of the beam path. The accelerated, high-speed beam of electrons can be guided to output from the beam path to a target device using an extraction channel coupled to the beam path. The energy of the output beam of electrons can be adjusted using electromagnets and/or a fast electrostatic kicker and septum magnet. The high-speed beam of electrons can be guided to a target device to be used for isotope production, medical treatment, medical sterilization, food processing, water treatment, or another application using a beam of electrons. In some embodiments, the beam of electrons are pre-accelerated using one or more additional linacs before being injected into the RTM. The additional linac(s) and the RTM can work together to accelerate the beam of electrons to a velocity asymptotically approaching the velocity of light.

At 452, the RTM is provided with the CW RF electromagnetic energy produced by a magnetron. The linac and the beam path of the RTM are configured for low gradient acceleration of the beam of electrons that requires a peak RF power available from the magnetron. An example of the magnetron is the 1,497 MHz magnetron developed by Muons, Inc.

It is to be understood that the above detailed description is intended to be illustrative, and not restrictive. For example, there are many choices of frequencies, number of passes through the magnets, magnet types, and energy levels. Any specific frequency, number of passes through the magnets, magnet type, or energy level mentioned or implied in the above detailed description is intended to be an example for illustrative rather than restrictive purposes. Other embodiments will be apparent to those of skill in the art upon reading and understanding the above description. The scope of the invention should, therefore, be determined with reference to the appended claims, along with the full scope of equivalents to which such claims are entitled.

What is claimed is:

1. A system for producing a high-speed beam of electrons, comprising:
a racetrack microtron (RTM) configured to receive a beam of electrons and to accelerate the received beam of electrons using continuous wave (CW) radio-frequency (RF) electromagnetic energy, the RTM including a linear accelerator (linac) integrated with a racetrack-shaped beam path including two semicircular sections connected between two straight sections; and
a magnetron coupled to the RTM and configured to provide the RTM with the CW RF electromagnetic energy,
wherein the linac and the beam path are configured for low gradient acceleration of the beam of electrons that requires a peak RF power available from the magnetron.

2. The system of claim 1, further comprising a gridded electron gun coupled to the RTM and configured to produce the beam of electrons to be received by the RTM.

3. The system of claim 1, wherein the linac comprises one or more superconducting cavities.

4. The system of claim 3, wherein the one or more superconducting cavities each comprise a niobium-tin (Nb₃Sn)-based superconducting cavity.

5. The system of claim 4, wherein the one or more superconducting cavities comprise multiple superconducting cavities.

6. The system of claim 1, wherein the RTM further comprises permanent magnets each positioned at the semicircular sections of the beam path and configured to bend the beam of electrons for 180 degrees for recirculation in the beam path for repeatedly boosting energy of the beam of electrons using the linac.

7. The system of claim 1, wherein the RTM further comprises:
an extraction channel configured to output the beam of electrons from the beam path; and
means for adjusting energy of the output beam of electrons.

8. The system of claim 7, wherein the means for means for adjusting energy of the output beam of electrons comprises electromagnets.

9. The system of claim 7, wherein the means for means for adjusting energy of the output beam of electrons comprises a fast electrostatic kicker and septum magnet.

10. The system of claim 1, further comprising an electron source configured to produce the beam of electrons, and wherein the RTM is configured to be coupled to the electron source directly to receive the beam of electrons from the electron source directly.

11. The system of claim 1, further comprising:
an electron source configured to produce the beam of electrons; and
an additional linac configured to be coupled between the electron source and the RTM, to receive the beam of electrons from the electron source, and to pre-accelerate the beam of electrons,
and wherein the RTM is configured to be coupled to the additional linac to receive the pre-accelerated beam of electrons as the beam of electrons.

12. The system of claim 11, wherein the additional linac comprises multiple superconducting cavities having difference values of beta.

13. The system of claim 11, wherein the linac comprises multiple identical superconducting cavities.

14. A method for producing a high-speed beam of electrons, comprising:
accelerating a beam of electrons using a racetrack microtron (RTM) powered by continuous wave (CW) radio-frequency (RF) electromagnetic energy, the RTM including a linear accelerator (linac) integrated with a racetrack-shaped beam path including two semicircular sections connected between two straight sections; and
providing the RTM with the CW RF electromagnetic energy produced by a magnetron,
wherein the linac and the beam path are configured for low gradient acceleration of the beam of electrons that requires a peak RF power available from the magnetron.

15. The method of claim 14, further comprising:
producing the beam of electrons using a gridded electron gun; and
injecting the beam of electrons into the RTM.

16. The method of claim 14, further comprising bending the beam of electrons in the beam path using permanent magnets each positioned at the semicircular sections of the beam path.

17. The method of claim 14, further comprising:
extracting the beam of electrons from the beam path using an extraction channel coupled to the beam path; and
guiding the extracted beam of electrons to a target device to be used for at least one of isotope production, medical treatment, medical sterilization, food processing, or water treatment.

18. The method of claim 17, further comprising adjusting energy of the extracted beam of electrons using at least one of electromagnets or a fast electrostatic kicker and septum magnet.

19. The method of claim 14, further comprising pre-accelerating the beam of electrons using an additional linac, and wherein accelerating the beam of electrons using the RTM comprises accelerating the pre-accelerated beam of electrons using the RTM.

20. The method of claim 14, furthering comprising operating the RTM and the magnetron at 1,497 MHz.
